(19) United States
(12) Patent Application Publication
(10) Pub. No.: US 2003/0177277 A1
(43) Pub. Date: Sep. 18, 2003

(54) System and method for personal referrals

(76) Inventor: Ziv Dascalu, Ra'Anana (IL)

Correspondence Address: DR. D. GRAESER LTD., C/O THE POLKINGHORNS, 9003 FLORING WAY, UPPER MARLBORO, MD, 20773, US

(21) Appl. No.: 10/097,746

(22) Filed: Mar. 15, 2002

(51) Int. Cl. G06F 9/46

(52) U.S. Cl. 709/313

(57) ABSTRACT

A system and method for automatically supporting personal referrals, between an individual seeking the referral (hereinafter, the seeking individual) and the individual who is able to perform the referral (hereinafter, the referring individual). The objective of such a personal referral is to enable the seeking individual to receive assistance from the referring individual in contacting a target individual, for example in order to have an initial meeting between the seeking individual and the contact individual. For example, the contact individual could optionally be an executive at a company with which the seeking individual wishes to have a business relationship.

### FIELD OF THE INVENTION

The present invention is of a system and method for personal referrals, and in particular, for such a system and method in which an automated mechanism is provided for effecting and managing such referrals, at least in the initial stages.

### BACKGROUND OF THE INVENTION

Personal referrals, or “contacts”, are an important aspect of business activities. The ability of executives to contact each other, and to receive a favorable response to at least the initiation of contact, may determine whether a particular agreement or other business goal is reached. Although business activities are typically considered to be “objective”, such that the importance of personal relationships between individuals conducting such business is downplayed, in fact these personal relationships are essential for performing business activities. Indeed, individuals who lack these personal relationships may also have difficulty in reaching even an initial stage of a particular business activity with a company, as these individuals may be unable to arrange even a first meeting with the decision makers (executives who have the authority to make a decision concerning the business proposal) at the company.

Unfortunately, there is currently no solution to this problem. Various consultants and other types of individuals may attempt, professionally or on an ad hoc basis, to assist in the initiation of contacts. However, the requirement for contacting other individuals in order to reach those executives who are able to make decisions is clearly a drawback. Individuals, such as the owners of small businesses, who are not already familiar to these executives and/or acquaintances of the executives, may not even be able to reach them for an initial conversation.

### SUMMARY OF THE INVENTION

The background art does not teach or suggest a system or method for automatically supporting personal referrals. In addition, the background art does not teach or suggest such a system or method which is able to manage these personal referrals. Furthermore, the background art also does not teach or suggest such a system and method in which financial or other types of remuneration are provided to an individual who assists with such a referral, and/or with the initiation of a business contact.

The present invention overcomes these deficiencies of the background art by providing a system and method for automatically supporting personal referrals, between an individual seeking the referral (hereinafter, the seeking individual) and the individual who is able to perform the referral (hereinafter, the referring individual). The objective of such a personal referral is to enable the seeking individual to receive assistance from the referring individual in contacting a target individual, for example in order to have an initial meeting between the seeking individual and the contact individual. For example, the contact individual could optionally be an executive at a company with which the seeking individual wishes to have a business relationship.

As used herein, the term “support” includes any activity related to, or assisting with, a personal referral, including but not limited to any one or more of the following, transmitting communication between a seeking individual and a referring individual; locating a referring individual for a seeking individual; optionally providing financial or other remuneration to the referring individual, as well as optionally collecting such remuneration from the seeking individual; assisting in the initial negotiation between a seeking individual and a referring individual; and filtering requests from seeking individuals and/or responses from referring individuals; or any other such supporting action.

The method according to the present invention for supporting such personal referrals preferably at least includes registering a plurality of users to the system, including at least referring users but more preferably also including seeking users; searching for at least referring user by a seeking user, which optionally and more preferably also includes a filtration process, in order for the seeking user to receive only information of interest; communicating between the seeking user and the referring user, preferably, as an anonymous communication session; if successful, exchanging contact and identifying information by the seeking and referring users; and executing the agreement between the seeking and referring users, preferably also including examining the successful execution by the system of the present invention, in order to determine whether all necessary procedures were performed.

The present invention is preferably implemented through a system of a plurality of computational devices connected to a server. The server preferably executes one or more instructions for performing the method of the present invention, for example by operating a software program. The server is also more preferably in communication with a database, which stores the necessary information for supporting these personal referrals.

According to preferred embodiments of the present invention, each computational device, or client, which is connected to the server provides a user interface to the user. The user may be for example a seeking individual and/or a referring individual. The user interface preferably enables that individual to obtain information from the database which is connected to the server. Optionally and preferably, the user interface is provided through a Web browser, such that the server is optionally and preferably a Web server, although alternatively the user interface is provided through some other type of GUI (graphical user interface). It should be noted that the term “Web” includes but is not limited to data transmitted according to the HTTP (hyper text transfer protocol) and any other protocol which is suitable for transmitting data over a network such as the Internet for example, and which is more preferably suitable for the transmission of data according to a client-server model.

Hereinafter, the term “computational device” includes, but is not limited to, personal computers (PC) having an operating system such as DOS, Windows™, OS/2™ or Linux; Macintosh™ computers; graphical workstations such as the computers of Sun Microsystems™ and Silicon Graphics™, and other computers having some version of the UNIX operating system such as AIX™ or SOLARIS™ of Sun Microsystems™; or any other known and available operating system, or any device, including but not limited to: laptops, hand-held computers (based on operating systems such as EPOC and Windows CE), PDA (personal digital assistant) devices (e.g. Palm Pilot), cellular telephones, two-way pagers, any type of WAP (wireless application protocol) enabled device, wearable computers of any sort, and any device which can be connected to a network as previously defined and which has an operating system. Hereinafter, the term “Windows™” includes any version of this operating system by Microsoft Corp. (USA).

For the present invention, a software application could be written in substantially any suitable programming language, which could easily be selected by one of ordinary skill in the art. The programming language chosen should be compatible with the computational device according to which the software application is executed. Examples of suitable programming languages include, but are not limited to, C, C++ and Java.

In addition, the present invention could optionally be implemented as software, firmware or hardware, or as a combination thereof. For any of these implementations, the functions performed by the method could be described as a plurality of instructions performed by a data processor.

### BRIEF DESCRIPTION OF THE DRAWINGS

The invention is herein described, by way of example only, with reference to the accompanying drawings, wherein:

FIG. 1. is a schematic block diagram of an exemplary system according to the present invention;

FIG. 2 is a schematic block diagram of an exemplary database structure according to the present invention;

FIGS. 3A and 3B are flowcharts of exemplary methods according to the present invention for user registration and access to the system of the present invention; and

FIGS. 4A-4C are flow diagrams of illustrative implementations of particular operations, given in more detail, for supporting the methods of FIG. 3 according to the present invention.

### DESCRIPTION OF THE PREFERRED EMBODIMENTS

The present invention is of a system and method for automatically supporting personal referrals, between an individual seeking the referral (hereinafter, the seeking individual) and the individual who is able to perform the referral (hereinafter, the referring individual). The objective of such a personal referral is to enable the seeking individual to receive assistance from the referring individual in contacting a target individual, for example in order to have an initial meeting between the seeking individual and the contact individual. For example, the contact individual could optionally be an executive at a company with which the seeking individual wishes to have a business relationship.

The present invention is of a system and method for automatically supporting such personal referrals. The method according to the present invention for supporting such personal referrals preferably at least includes registering a plurality of users to the system, including at least referring users but more preferably also including seeking users; searching for at least referring user by a seeking user, which optionally and more preferably also includes a filtration process, in order for the seeking user to receive only information of interest; communicating between the seeking user and the referring user, preferably, as an anonymous communication session; if successful, exchanging contact and identifying information by the seeking and referring users; and executing the agreement between the seeking and referring users, preferably also including examining the successful execution by the system of the present invention, in order to determine whether all necessary procedures were performed.

Preferably, the present invention is at least able to provide information about referring individuals to seeking individuals. More preferably, the present invention also enables some type of initial contact to occur between referring and seeking individuals, which is optionally and more preferably anonymous, such that the identity of at least one, and more preferably both, of the referring and seeking individuals remains unknown to the other party.

Optionally and most preferably, the present invention also includes a search function, for enabling the seeking individual to search for one or more suitable referring individuals. Such a search function is most preferably implemented as an automatic matching function, such that the seeking individual enters one or more characteristics for a referring individual and the automatic matching function attempts to provide at least one referring individual who matches the entered characteristic(s). It should be noted that at least one characteristic of the referring individual may describe a relationship between that individual and a target individual. Furthermore, the target individual may optionally be an actual person, and alternatively or additionally, may be an individual holding a position at a particular company and/or a particular type of company.

According to preferred embodiments of the present invention, there is optionally and preferably provided one or more filters, for filtering information contained in the database and/or for filtering information received from any one or more of a seeking individual and a referral individual. A filter is preferably able to reduce or at least organize the information which is entered into, or received from, the system of the present invention. For example, a seeking individual is optionally and more preferably able to filter information about referral individuals according to one or more characteristics of the referral individual, or at least to have the system perform such filtration.

According to optional but preferred embodiments of the present invention, there is provided a mechanism for providing financial or other remuneration to the referring individual. More preferably, the seeking individual provides a certain remuneration through the system of the present invention to the referral individual, most preferably before the referral (contact with the target individual) is performed. The system of the present invention is preferably able to automatically transmit such remuneration. Optionally and more preferably, a portion of this remuneration is retained as a fee for using the system itself.

The principles and operation of the present invention may be better understood with reference to the drawings and the accompanying description. It should be noted that although this description centers around the operation of the present invention with regard to business contacts, this is for the purposes of illustration only and is not intended to be limiting in any way.

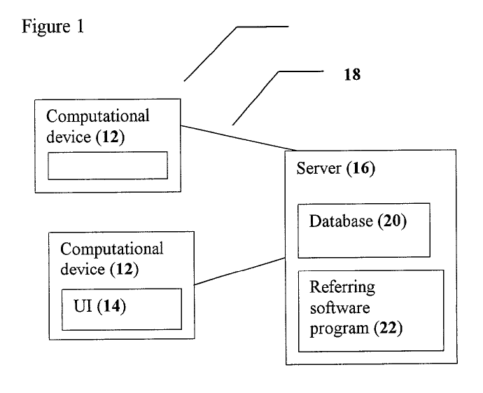

Referring now to the drawings, FIG. 1 is a schematic block diagram of a system according to the present invention for supporting personal referrals. As shown, a system 10 features a plurality of computational devices 12 for being operated by users (not shown). Each computational device 12 optionally and preferably features a user interface 14 for operation by the user, which is more preferably a GUI (graphical user interface). A non-limiting example of a suitable GUI may be provided through a Web browser, for example. The GUI may optionally be implemented as a stand-alone application or alternatively as a plug-in software module to a Web browser, for example.

Each computational device 12 is connected to a server 16, preferably through a network 18 which may optionally be the Internet for example. Server 16 may optionally be implemented as a plurality of serving devices (not shown). Server 16 is preferably in communication with a database 20, in which data related to the personal referrals is preferably stored. Server 16 also optionally and preferably operates a referral software program 22, for performing one or more functions according to the method of the present invention, as described in greater detail below.

As an example, if a seeking user wishes to obtain information about a possible referring individual, for example in order to contact a particular target individual, the seeking user preferably enters one or more characteristics of the desired referring individual and/or target individual into user interface 14 of computational device 12. The one or more characteristics are sent to server 16, which preferably searches through database 20 for suitable referring individual(s). Optionally, server 16 may initially only return partial information, for example in order to ensure payment by the seeking user.

One or both of server 16 and user interface 14 may also optionally provide various functions for message management, spell and/or grammar checking, management and display of multiple threads or sets of communications between seeking and referring users, and so forth, in order to assist referring and seeking users in contacting each other. As described in greater detail below, such contact may optionally be required to be anonymous, at least initially. The anonymity of contact may optionally and preferably be managed by server 16. Server 16 may also optionally and more preferably provide such services as time stamping, encryption and signatures for messages, in order to provide substantiation for the identity of the sender and/or recipient, and/or time of sending/receiving of the message.

It should be noted that any type of access device may optionally be used to communicate with server 16, including but not limited to, a desktop computer, a portable computer, a PDA (personal data assistant), a handheld computer, a mobile telephone or other type of wireless communication device, a television set (optionally with set-top box), an interactive television set, facsimile and so forth. Furthermore, any type of communication medium or mechanism may optionally be used for communication by the referring and/or seeking user with the system according to the present invention, including but not limited to, text, voice communication and/or other types of audio data, video data, through a human broker or any other type of suitable communication.

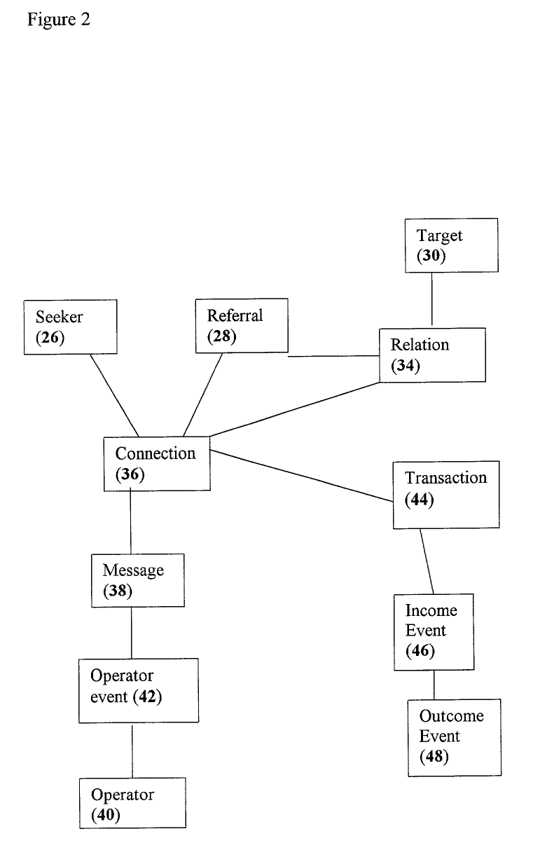

FIG. 2 is a schematic block diagram of an illustrative database structure for the database of FIG. 1. This illustrative database structure preferably includes a plurality of tables as shown, for the preferred implementation of the database structure according to the present invention as a relational database.

In order to be able to store information about various users of the system according to the present invention, the database preferably features user information, which is more preferably information about individuals who interact with the system of the present invention. Such information more preferably includes such details as a user identifier and one or more personal details about the user. For example, for a seeking user, the details may optionally and more preferably include such information as credit card or other payment mechanism data, name, address, occupation and/or position, and so forth. According to preferred embodiments of the present invention, if another user is able to induce a seeking and/or referral user to enter the system according to the present invention, details of this recruiter are also preferably included.

The user information optionally and more preferably is stored in a seeker user table 26 and a referral user table 28. As their names suggest, these tables contain information about those users seeking a contact with a target individual, and about those users who may optionally be able to support such contact, respectively. Examples of some types of information which may optionally be included in seeker user table 26 were previously described. Referral user table 28 optionally and more preferably includes, in addition to or in replacement of this information, details about one or more of geographical area, qualification and experience, fees (meeting fee, finder's fee, etc) which may optionally be charged by that referring user, and status (active/inactive). The status indicator may optionally allow a referral to stop receiving messages from new seekers, perhaps temporarily, but continue to handle already existing relationships.

A target table 30 preferably contains information about each target, which may optionally be a particular individual, an individual having a particular position, a company, or a combination thereof. Target table 30 preferably contains such information as a target identifier, and personal details (which are optional, particularly if the target is the company itself).

Each target is optionally and more preferably associated with a company and/is the company and/or a part of the company, such as a department for example. Information about each company optionally and preferably includes but is not limited to, a company identifier, for example; company details such as name, address and so forth; areas of activity; and geographical regions where it is active and status (waiting, final).

A relation table 34 preferably includes information about the relationship between a referral user and a target (user and/or company). Relation table 34 may also optionally include such information as relation details (type, length), likelihood of creating a contact for a seeking user, other fees that are specific to this relation and optionally comments in free text.

A connections table 36 preferably includes information about communication which was supported through the system of the present invention, in order to attempt to make a referral between a seeking user and the target by the referral user. More preferably, details about each such attempt are stored, including a connection identifier, a relation identifier for pointing to a relation in relation table 34, a seeker identifier for pointing to the seeking user, a referral identifier for pointing to the referring user, and also optionally information about the status of the proposed connection.

Information about the status of the proposed connection more preferably includes, but is not limited to, one or more of the following: Anonymous—request for contact was sent from seeker to referral; Referral_approved; Referral_rejected; Operator_approved; Operator_rejected; Seeker_approved and Seeker_rejected. The terms “operator_approved” and “operator_rejected” optionally and more preferably refer to an optional but preferred embodiment of the present invention, in which an operator controls one or more aspects of the personal referral process.

The referral process may also optionally include sending messages between different components of the system of the present invention, such as the seeking user and the referring user, for example. Each message table 38 preferably includes one or more of the following information: a message identifier; a notification identifier; a connection identifier (points to connections in connection table 36); a sender (points to the user who sent the message); a recipient (points to the user who received the message); a date; a message type; and a message status. Examples of the message status according to the present invention include, but are not limited to, one or more of the following; Waiting (for operator approval); Rejected (by an operator); and Approved (now the recipient can see it). Examples of a message type include but are not limited to, one or more of the following: simple message, request for contact, reject message, accept message, and target suggestion.

These messages may optionally be translated, preferably automatically, by the system of the present invention. A variety of software algorithms are available for performing such a translation, which could easily be selected by one of ordinary skill in the art.

Anonymous messages are preferably scanned for the inclusion of contact information, which could allow the seeking and/or referring user to by-pass the system of the present invention and to directly initiate contact, for example in order to avoid payment to the system. Such scanning may optionally and more preferably be performed automatically, but may alternatively be performed manually, for example by an operator (described below). If contact information is included in a non-permitted message, the message is preferably rejected by the system.

For the preferred embodiment of the present invention in which a human operator exerts at least partial control over the referral process, an operator table 40 is preferably provided, which includes information about the operator. Such information includes but is not limited to, an operator identifier, personal details about the operator, and position information, such as the rank and type of operator, and so forth.

Each operator may optionally interact with the system of the present invention, thereby generating an operator event 42. Each operator event is preferably identified with an operator event identifier and the identifier of the operator. Other optional information includes but is not limited to, a type of operator event (message, connection, new target, new company, payment of all sorts), and description (preferably free text for describing the reasoning for event handling).

A transaction table 44 preferably includes information about one or more transactions between seeking users and referral users within the system of the present invention. For example, this information may optionally include a transaction identifier, a connection identifier and a status indicator. Since the goal of each transaction is support a personal referral between a seeking user and a referring user, transaction table 44 is optionally and more preferably divided into an income event table 46 and an outcome event table 48.

Income event table 46 preferably includes such information as an income event identifier, a description, a date, a transaction identifier, a type (Connection fee, direct contact, other fee), an amount, a system income (calculated from percentage and amount), a system credit identifier and a percentage of the fee which may optionally be charged by the system of the present invention.

Outcome event table 48 preferably includes such information as a pointer to the incoming event which generated that outgoing event, a notification identifier, an outcome identifier, a beneficiary identifier for relating to one or more referral users, a percentage of the fee to be deducted, an outcome amount (calculated from amount of related income event and percentage), a date and a system debit identifier. The latter identifier is preferably entered once the payment has been performed.

Although not shown, both the database and the server according to the present invention are preferably connected to a conventional billing system, for charging the seeking users according to the method of the present invention.

According to other preferred embodiments of the present invention, there is preferably provided a method of rating the referring users. For example, such rating may optionally be provided by a controlling operator as previously described. More preferably, the rating is additionally or alternatively provided by a seeking user. Most preferably, such ratings are provided anonymously. Also most preferably, such ratings include statistical information about the quantitative performance of the referring user, such as the number of seeking users who approached the referring user; the number of seeking users who were able to have at least an initial meeting with the target or individual at the target (for a company); the number of seeking users who were able to close an agreement with the target; and so forth. The rating may also optionally include a measure of the successful and non-successful transactions performed by the referring user.

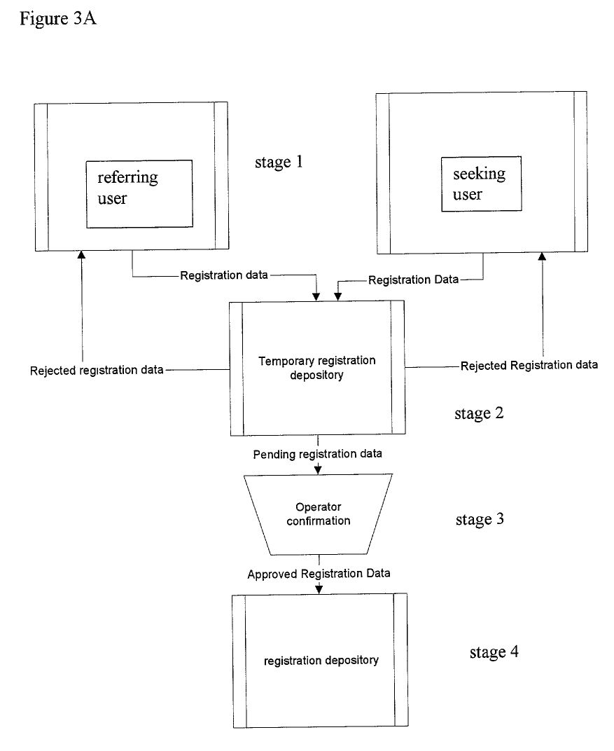

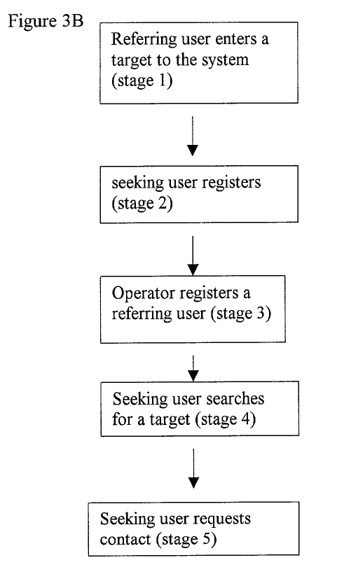

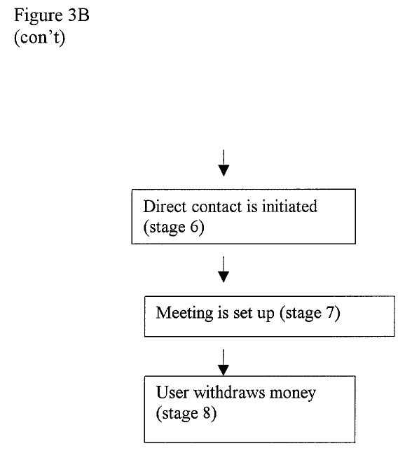

FIGS. 3A and 3B show flowcharts of exemplary methods according to the present invention for automatically supporting a personal referral. As shown with regard to FIG. 3A, preferably both the seeking users and the referring users must register in order to access and/or receive services from the system according to the present invention. Both types of users preferably enter registration information in stage 1. Such registration information optionally and preferably includes but is not limited to, personal user details such as user address, zip code, and telephone number; e-mail address of the user; and work-related details of the user (such as occupation and so forth). Referring users may optionally be required to also send information in order to demonstrate the credentials of such a user in order to be able to refer the seeking user to a target. The referring user may also optionally be required to give one or more examples of the personal connections of that user. One or both of the referring and seeking users may optionally and preferably give information about their profession, field of specialization, type of company (and more preferably the company name itself), and so forth, in order to assist other users in seeking a referral of interest.

As part of this process (not shown), a usage contact is optionally and preferably sent to the registering user, for example by e-mail. This user preferably must return this contract with a note of confirmation of terms in order for the registration to be in effect.

Next, in stage 2, the registration data is optionally and preferably placed in a temporary registration directory. In stage 3, an operator more preferably examines and confirms the registration data, although alternatively such an examination could be performed automatically.

In stage 4, if the registration data is confirmed, then preferably the registration data is stored in a registration depository. Alternatively, if the data is rejected (and hence the requested registration is also rejected), then preferably notification of such a rejection is returned to the referring or seeking user. More preferably, the registration only becomes effective after such approval by the operator.

According to optional but preferred embodiments of the present invention, a user who is already a member of the system of the present invention preferably receives some type of reward when a new referring or seeking user registers according to recommendation by the member. Such a recommendation may optionally and preferably be recognized according to a URL extension and/or free text label. More preferably, the member receives some type of compensation for causing such a new user to be added to the system (such as a percentage of the fees paid into the system of the present invention by the recommended user, for example).

According to other optional but preferred embodiments of the present invention, a potential seeking user may optionally be allowed to perform some type of initial or restricted search before deciding to register with the system of the present invention.

As shown with regard to FIG. 3B, first the user enters a target into the system, as shown in stage 1. Such entry preferably includes entering the company's name. Next, the system checks if a company with similar name exists and proposes options to the user.

The user may optionally choose an existing company and update its details, and/or may alternatively enter the details of a new company, including geographical location, types of industries involved and competitors. The geographical and/or industry-based searches may optionally be presented as a map and/or hierarchical tree structure.

A company log is created in the database (if needed). The user optionally and more preferably enters the target person's name. The system preferably checks if a target with a similar name exists and proposes options to the user. The user optionally chooses an existing target and also optionally updates its details, and/or alternatively enters the details of a new target.

A target log is created (if needed). The user optionally and more preferably enters the relationship details and a relation log is preferably created in the database.

Next, an operator event is optionally and preferably created, with status waiting. An operator receives a notification that target details are to be approved. After the operator fixes and approves the target details, the status of company, target and relation is preferably finalized.

According to preferred embodiments of the present invention, the referring user cannot change details of targets and companies that are already in the system. The referring user can preferably only suggest an update to these details that an operator should approve.

In stage 2, the seeking user registers with the system according to the present invention. In stage 3, the operator may optionally be required to register and approve of a new referring and/or seeking user (see for example the method described in FIG. 3A).

In stage 4, the seeking user preferably attempts to search for a target of interest. For example, the seeking user may optionally enter a company name and/or domain (area of activity), and/or may optionally search by industry and/or geographical location.

The seeking user preferably receives a list of targets in this company. The seeking user can at this stage optionally refine the search based on other parameters.

The seeking user preferably chooses a target from the list of target. The seeking user is preferably presented with a list of referring users to this target. This list is optionally and more preferably filtered according to various criteria, including seeker's credits and currently open connections of the referring user. The details that are displayed concerning each referral preferably include but are not limited to, a type of connection the referral has with the company or target person; a length of relationship; ratings about the abilities of the referring user; geographical area of the referring user; referring user qualification and experience; statistical information and referral fees (meeting fee, direct contact fee, finder's fee).

Additionally or alternatively, the seeking user may search for a referring user according to any characteristic of the referring user, including but not limited to, rating of the referring user by previous seeking users; details provided by the referring user during registration; industries in which the referring user has had previous experience (which may optionally differ from the industries in which the referring user is able to provide a referral); open connections of that referring user; and price. By “open connection” it is meant referral processes being performed by the referring user, in any stage of performance (negotiation, execution, post-execution payment and so forth, for example). The seeking user may also, additionally or alternatively, be limited to the number of referrals being sought and/or otherwise in process.

The price (fee charged by the referring user) may optionally be provided as part of the search information to the seeking user, and/or may also optionally be used as a search criterion for performing the search. The referring user may optionally set the fee, but preferably the system suggests a fee to the referring user, more preferably according to one or more factors such as the type of industry, type of target being sought, professional level of the referring user, ratings of that referring user and so forth.

Both seeking users and referring users may optionally and more preferably suggest one or more criteria for filtering of the search results, in order to prevent them from initiating contact with a party that they would not wish engage in the referral process. Examples of such criteria include but are not limited to, company size (for the seeking user and/or referring user, or according to the target); yearly volume of sales for that company; and position or level of responsibility of the seeking user and/or referring user.

These types of more general filtering criteria are preferably performed at least if the seeking user wishes to seek a more general type of target. For example, rather than searching for a referral to a particular individual and/or an individual within a particular company, the seeking user may optionally seek an individual holding a position with a company in a particular industry and/or geographical area. Therefore, the general characteristics of the company may be important.

Collaborative filtering may also optionally be performed, which is assisted by these types of more general filtering criteria. Such filtering enables the system to suggest particular targets, such as particular companies for example, according to the search criteria of the seeking user.

According to other preferred embodiments of the present invention, if the seeking user is not able to locate a referring user of interest, the seeking user may optionally transmit a message to the system. This message may optionally enable a referring user to determine whether to respond to the seeking user, thereby reversing the typical flow of initial communication according to the present invention. For example, the message could optionally be sent automatically to all referring users associated with a particular industry and/or a particular company.

Next, in stage 5, the seeking user preferably requests contact with a referral user, which is more preferably performed as an anonymous session, in which both the seeking user and the referring user are more preferably anonymous. In this stage, optionally and preferably, a message log is created in the database. Also optionally and preferably, a connection log is created in the database, connected to the seeking user, referral and relation, more preferably with status set to anonymous.

An operator preferably receives a notification about the message. If the operator approves it, the referring user receives a notification that a message is waiting, regarding a new connection. If the operator does not approve the message, a warning log is created and the seeking user also preferably receives a notification to that effect.

The referring user can optionally send one of a number of different responses. For example, the referring user may optionally respond with a message asking for more details, or alternatively may send a rejection message, suggest another target or send a request for direct contact. In any case a log of the message is preferably created.

According to preferred embodiments of the present invention, this process of message exchange at least enables, and more preferably requires, the referring user and the seeking user to remain anonymous. Every message is optionally and more preferably reviewed for approval by an operator.

According to other preferred embodiments of the present invention, a seeking user may optionally send a broadcast message to all of the referring users in an industry. More preferably, these referring users may respond by recommending a possible target.

According to still other preferred embodiments of the present invention, one or both of the referring and seeking users are able to filter requests and/or other messages from other users which do not fit one or more criteria. These criteria may optionally be specified in a user profile. Filtration may also optionally be performed according to their performance statistics.

In stage 6, more preferably, direct contact is created between the seeking and referring users, which is most preferably non-anonymous contact. Optionally and most preferably, such direct contact is only permitted if the seeking user receives a request for direct contact from the referring user.

The connection status is preferably changed to Referral_approved. The seeking user optionally and preferably approves the request by entering payment details, such as a credit card number for example, and approval to pay the fee. The connection status is then preferably changed to Seeker_approved. An income event log is also created. An operator event is preferably created, connected with the income event.

The operator then receives a notification that an income event is to be approved. The operator approves (and actually performs) the event. A system credit log is created and its identifier is entered in the income-events log.

The connection status is then preferably changed to operator_approved, such that the seeking and referring users are preferably no longer anonymous to each other.

The system optionally and preferably checks if one or more of the seeking and referring users have recruiters. For each recruiter an outcome event log is created, connected with the income event log and the beneficiary log (recruiter).

In stage 7, a meeting is set up between the target and the seeking user, through the referring user. Alternatively, preferably as negotiated between the seeking user and the referring user, some other type of contact is initiated. Effecting such a meeting may optionally also cause another income event to be generated, such that the seeking user preferably pays an additional fee.

In stage 8, a user withdraws money from system. For example, the user may be a referring user who has collected fees for performing this service. The user enters a form, requesting to withdraw money. A withdrawal log is preferably created, indicating that money is leaving the system. Such a withdrawal may optionally and preferably require operator approval, such that an operator receives a notification about the withdrawal, for example through an operator event, and the amount of money. An outcome event is preferably created with the sum requested by the user. A system debit log is also more preferably created.

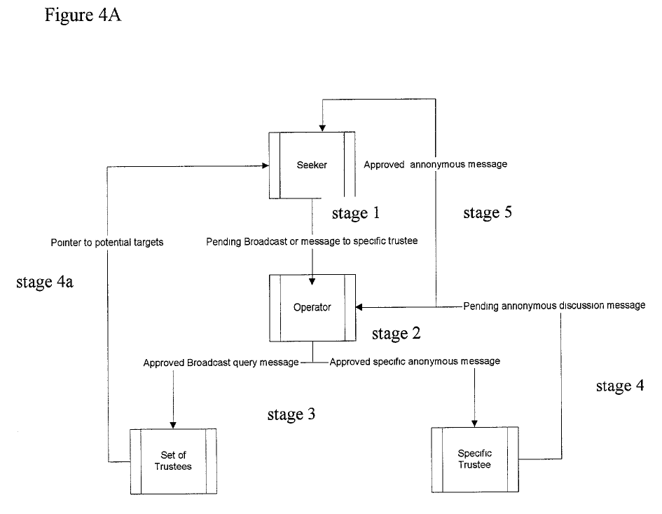

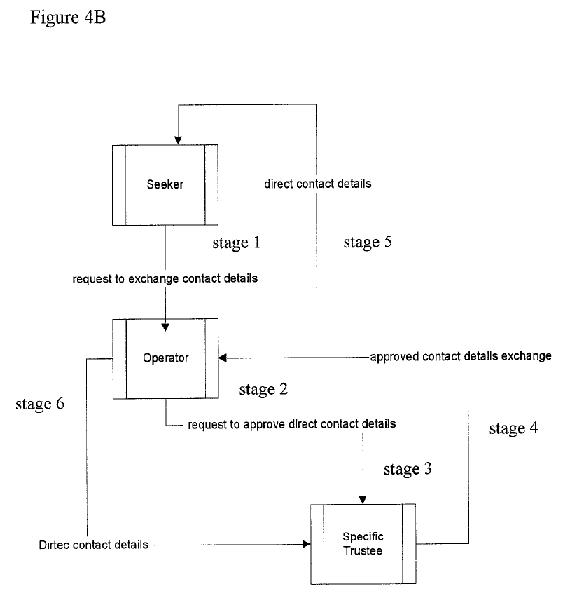

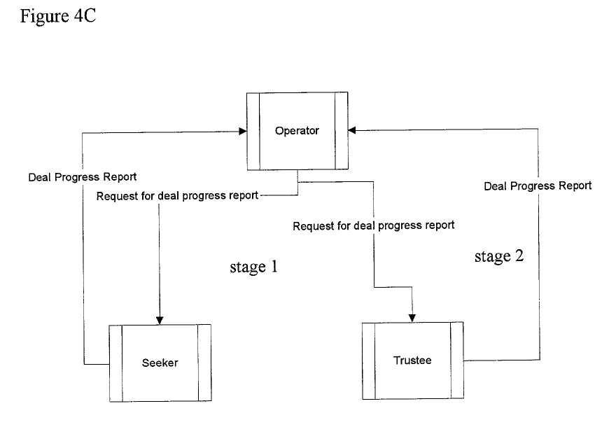

FIGS. 4A-4C show flow diagrams relating to particular types of contact between a seeking user and a referring user, with or without the intervention and/or monitoring of an operator. As shown in FIG. 4A, a seeking user sends a message for requesting contact to at least one referring user in stage 1. The message may optionally be directed to one referring user, for a specific message, or alternatively may be directed to a plurality of referring users, for a broadcast message.

Since the initial contact is preferably anonymous, as previously described, an operator preferably initially receives the message, in stage 2. The operator preferably is required to approve the message, before it can be passed to the intended recipient(s). For example, if a human operator manually reviews the message, the message may optionally be examined for non-allowed contact information and/or other information. In stage 3, if the message is approved, then the operator preferably sends the message to one or more referring users.

In stage 4, for the individual referring user, if that user wishes to accept the message, then the referring user preferably sends back a message, more preferably through the operator, in order to establish contact with the seeking user. In stage 5, if the operator must give an approval and if that message is approved, the seeking user receives the message. If no operator is present, then the seeking user preferably receives the message directly.

In stage 4a, for a message broadcast to a plurality of referring users, one or more referring users may optionally choose to reply by suggesting a target with whom that referring user has a connection. Such a suggestion message may optionally be sent directly as shown, or alternatively may be sent through an operator. More preferably, the system optionally prevents the seeking user from sending the same message to a plurality of referring users, or at least alerts the referring users to the fact that such a message has been sent to multiple referring users. Such prevention and/or alerting of the referring users are preferably performed regardless of whether the message is sent to a plurality of referring users simultaneously or sequentially.

FIG. 4B shows an optional and preferred exemplary method for exchanging contact information in particular, more preferably after initial contact has been established between the seeking user and the referring user, for example as performed with regard to FIG. 4A. This method enables both parties to exchange such contact information for direct communication.

Although one or both of the seeking user and the referring user may optionally request exchange of contact information, the method is illustrated with regard to a request from the seeking user for the purposes of description only and without any intention of being limiting. As shown, in stage 1 the seeking user sends a request for exchanging contact details.

Preferably, in stage 2, the operator receives the request. In stage 3, the operator preferably sends a request to the referring user. Alternatively, the request is sent directly from the seeking user to the referring user.

In stage 4, if the referring user wishes to approve the request, the referring user sends an approval message. Preferably, the approval message is sent to the operator. If the operator approves, then in stage 5 the operator sends the approval message to the seeking user. Alternatively, the approval message may be sent directly to the seeking user. The approval message preferably includes the direct contact details of the referring user.

In stage 6, if these contact details were not included in the request for contact message from the seeking user, then these contact details are sent (directly or through operator) to the referring user.

More preferably, one or both of the request and approval messages are sent through the operator, in order to control the disclosure of contact information. For example, the system of the present invention may optionally require payment of a fee by the seeking user before such disclosure can occur.

FIG. 4C is a flow diagram of an exemplary method for monitoring the progress of execution of the referral. This method may optionally feature one or more processes executing concurrently and/or being performed repeatedly. As shown, in stage 1, the operator (or another central entity, which may optionally be an automated software program for example) sends a request for a progress report on the status of execution of the referral. The request may optionally be sent to one or both of the seeking user and referring user.

In stage 2, the seeking user and/or referring user sends the progress report to the operator. Such a progress report may optionally include any one or more of the following: rating of the performance of the referring user and/or seeking user; status of the referral (for example, whether an initial meeting has been performed or at least scheduled with the target); and fees charged and/or paid to date. The progress report may optionally be sent by any suitable communication channel, including but not limited to, e-mail messages, facsimiles and so forth.

The system may optionally have one or more standard contracts or agreements, which preferably include such contracts or agreements that are tailored to particular industries, and which may optionally be provided by the operator upon receipt of the progress report.

The system of the present invention may optionally prepare aggregated performance statistics, on the performance of individual referring users and/or on the system as a whole. The system of the present invention may also optionally provide non-referral information, such as a link to other database resources and/or other types of information, for example. Such non-referral information more preferably includes information about the companies associated with a target, referring user and/or seeking user.

According to preferred embodiments of the present invention, various business processes may optionally be performed in conjunction with and/or supported by the system of the present invention. For example, the system of the present invention may optionally and preferably be in contact with a consulting service to guide at least one, and more preferably both, of the referring user and the seeking user in their use of the system. Analysis services may also optionally be provided, for example in order to analyze market trends and business opportunities. An analysis of the activities within the system may also optionally be performed, for example for statistical data and/or to detect market trends and/or individuals having relatively significant amounts of power, for example within a particular industry. Also, performance data related to the activities within the system may also optionally be sold.

Various legal and/or financial services are also optionally and preferably provided. For example, an escrow service is preferably provided, in order to guarantee payments. Legal services, such as writing contracts and providing written opinions, may also optionally be provided. Furthermore, an internal business development organization may optionally be associated with the system of the present invention.

According to other optional but preferred embodiments of the present invention, the seeking users may pay according to a subscription fee rather than “per use” fees, or a combination thereof. Also, preferably the referring user is able to designate at least a portion of the fees received for payment as a donation to a non-profit organization, such as a charitable organization for example.

Also optionally, the system of the present invention may also feature advertisements, promotions and/or other types of selling/buying activities which are not directly related to the referral service. Alternatively, a version of the system of the present invention could optionally be tailored to the requirements of a particular corporation for example.

In addition, optionally the system may examine potential referring users and/or seeking users, for example as part of a due diligence process. This process may also optionally be performed with regard to particular executions of referrals. Additionally or alternatively, a referring user may optionally have an agent who represents that referring user to the system of the present invention.

While the invention has been described with respect to a limited number of embodiments, it will be appreciated that many variations, modifications and other applications of the invention may be made.

What is claimed is:

1. A method for automatically supporting a personal referral, comprising:
receiving information about a relationship between a target and at least one referring user;
receiving a request for a referral to said target by a seeking user;
matching said request to said information about said relationship between said target and said at least one referring user;
if a match is found, notifying at least said seeking user.

2. The method of claim 1, wherein said matching said request is automatically performed according to at least one characteristic of said seeking user and at least one characteristic of said referring user.

3. The method of claim 1, further comprising:
exchanging at least one message between said seeking user and said referring user.

4. The method of claim 3, wherein said at least one message is exchanged anonymously at least once.

5. The method of claim 4, wherein a plurality of messages is exchanged between said seeking user and said referring user, and wherein at least one message is not anonymous and at least one message is anonymous.

6. The method of claim 5, further comprising:
receiving a request to exchange contact details by at least one of said seeking user and said referring user; and
exchanging said contact details in said non-anonymous message.

7. The method of claim 6, wherein said messages are anonymous until both said seeking user and said referring user approve said exchange of contact details.

8. The method of claim 7, further comprising:
paying a fee by said seeking user for the personal referral.

9. The method of claim 8, further comprising:
receiving a report from at least one of said seeking user and said referring user on a progress of an execution of the personal referral.

10. The method of claim 1, wherein said request for said referral is for a category of targets.

11. A method for automatically performing a personal referral to a target, comprising:
searching for a referring user by a seeking user;
communicating between said seeking user and said referring user;
if successful, forming an agreement between said seeking user and said referring user; and
executing the personal referral according to said agreement.

12. The method of claim 11, wherein before said seeking user searches for said referring user, registering at least said referring user.

13. The method of claim 12, wherein both said seeking user and said referring user are registered.

14. The method of claim 12, wherein registering at least said referring user includes submitting at least one personal characteristic about said referring user.

15. The method of claim 14, wherein a n operator approves of said registering of at least one of said referring user and said seeking user.

16. The method of claim 15, wherein searching for said referring user includes a filtration process for filtering said referring user according to said at least one personal characteristic.

17. The method of claim 11, wherein said communicating is at least initially performed as an anonymous communication session and wherein if successful, contact and identifying information are exchanged by said seeking and referring users.

18. The method of claim 17, wherein an operator approves of said exchange of said contact and identifying information.

19. The method of claim 11, further comprising:
examining said execution of the personal referral.

20. The method of claim 11, wherein before said seeking user searches for said referring user, said seeking user enters the target.

21. The method of claim 20, wherein entering the target comprises entering information about a specific target.

22. The method of claim 20, wherein entering the target comprises entering information about a category of target.

23. The method of claim 22, wherein entering the target includes entering at least one of geographical location, types of industries involved and competitors.

24. The method of claim 20, wherein searching for said referring user includes entering information about said referring user by said seeking user, wherein said information includes at least one of geographical location, types of industries involved and competitors.

25. The method of claim 20, wherein a request for a target is sent to a plurality of referring users by said seeking user.
